(19) United States
(12) Patent Application Publication
(10) Pub. No.: US 2020/0246915 A1
(43) Pub. Date: Aug. 6, 2020

(54) METHOD FOR MANUFACTURING LAMINATED STRUCTURE

(71) Applicant: TOYOTA BOSHOKU KABUSHIKI KAISHA, Aichi-ken (JP)

(72) Inventors: Shigetomi HONDA, Aichi-ken (JP); Makoto KITAHARA, Aichi-ken (JP)

(73) Assignee: TOYOTA BOSHOKU KABUSHIKI KAISHA, Aichi-ken (JP)

(21) Appl. No.: 16/780,106

(22) Filed: Feb. 3, 2020

(30) Foreign Application Priority Data
Feb. 6, 2019 (JP) 2019-019381

(51) Int. Cl. B23K 26/28; B32B 15/01; B32B 37/06; H02K 15/02; H02K 15/03; H02K 1/27

(52) U.S. Cl. CPC B23K 26/28; B32B 15/01; H02K 1/276; H02K 15/024; H02K 15/03; B32B 37/06

(57) ABSTRACT

A method for manufacturing a laminated structure which includes a laminated body formed by stacking plural metal plates and is configured such that the plural metal plates located at both ends in a stacking direction are welded to each other. The method includes firstly welding outer peripheral portions of the plurality of metal plates that lie on top of each other at a lower end of the laminated body placed on a placing surface, after the first welding, vertically inverting the laminated body upside down and placing the laminated body in position, and after the inverting, secondly welding outer peripheral portions of the plurality of metal plates that lie on top of each other at a lower end of the laminated body.

### CROSS-REFERENCE TO RELATED APPLICATIONS

The present application is based on Japanese patent application No. 2019-019381 filed on Feb. 6, 2019, the entire contents of which are incorporated herein by reference.

### TECHNICAL FIELD

The invention relates to a method for manufacturing a laminated structure.

### BACKGROUND ART

A laminated structure formed by stacking plural metal plates is used as a rotor of, e.g., a rotation electrical machine such as electric motor (see, e.g., JP 2017/225304).

The rotor constructed from the laminated structure described in JP 2017/225304 has a rotor core formed of plural electromagnetic steel sheets stacked along the rotational axis direction, and end plates provided on the rotor core at both ends in the rotational axis direction. In addition, in the rotor manufacturing method described in JP 2017/225304, the radially outward edges of the end plates are joined to the radially outward edges of the electromagnetic steel sheets by welding.

### SUMMARY OF INVENTION

### Technical Problem

The electromagnetic steel sheet may have a thickness error. Therefore, when, e.g., several hundred electromagnetic steel sheets are stacked, the accumulated thickness error may cause a reduction in parallelism of the rotor core and the resulting tilt of the rotor core with respect to the stacking direction. If the rotor core tilts with respect to the stacking direction in the manufacturing method described in JP 2017/225304, the welding locations at the both ends in the stacking direction of the rotor core are misaligned and this may cause quality degradation such as poor welding.

It is an object of the invention to provide a method for manufacturing a laminated structure that can meet an improved quality without being affected by the parallelism reduction caused by the thickness error of metal plates.

According to an exemplary embodiment of the invention, a method for manufacturing a laminated structure that comprises a laminated body formed by stacking a plurality of metal plates and is configured such that the plurality of metal plates located at both ends in a stacking direction are welded to each other, the method comprising:
firstly welding outer peripheral portions of the plurality of metal plates that lie on top of each other at a lower end of the laminated body placed on a placing surface;
after the first welding, vertically inverting the laminated body upside down and placing the laminated body in position; and
after the inverting, secondly welding outer peripheral portions of the plurality of metal plates that lie on top of each other at a lower end of the laminated body

### Effects of Invention

According to an exemplary embodiment of the invention, a method for manufacturing a laminated structure can be provided that can meet an improved quality without being affected by parallelism reduction caused by the thickness error of metal plates.

### BRIEF DESCRIPTION OF DRAWINGS

FIG. 1 is a configuration diagram illustrating a rotation electrical machine having a rotation electrical machine rotor manufactured by a manufacturing method in an embodiment of the present embodiment.

FIG. 2A is a perspective view showing the rotation electrical machine rotor.

FIG. 2B is a cross sectional view showing the rotation electrical machine rotor cut in an axial direction along a rotational axis O.

FIG. 3A is a plan view showing one core plate.

FIG. 3B is a plan view showing a first end plate;

FIG. 4A is an explanatory diagram illustrating a preparation step for setting a laminated body formed by stacking plural core plates.

FIG. 4B is a plan view showing the laminated body shown in FIG. 4A when viewed in a direction along the rotational axis.

FIGS. 5A to 5E are explanatory diagrams illustrating a welding step in which welding is performed on a laminated body formed by stacking the plural core plates and end plates, and the plates at both ends in an axial direction are joined, wherein FIG. 5B is an enlarged explanatory diagram illustrating welded joints of the plural core plates and the end plate.

### DESCRIPTION OF EMBODIMENTS

### Embodiment

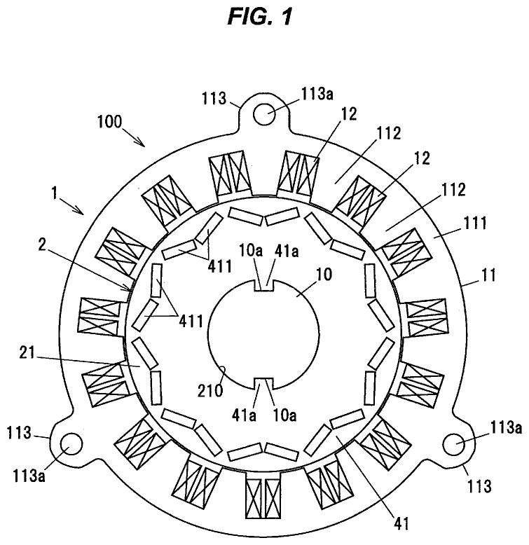

An embodiment of the invention will be described in reference to FIGS. 1 to 5. The embodiment below is described as a preferred example for implementing the invention. Although some part of the embodiment specifically illustrates various technically preferable matters, the technical scope of the invention is not limited to such specific aspects.

### Configuration of a Rotation Electrical Machine

FIG. 1 is a configuration diagram illustrating a rotation electrical machine having a rotation electrical machine rotor (hereinafter, simply referred to as “rotor”) formed of a laminated structure manufactured by a manufacturing method in an embodiment of the present embodiment.

A rotation electrical machine 100 has a stator 1 and a rotor 2. The stator 1 is nonrotatably fixed to a housing (hot shown). The rotor 2 has a rotor core 21 through which a shaft 10 is inserted at the center, and the rotor 2 rotates integrally with the shaft 10. The rotation electrical machine 100 is configured as a motor generating a drive force, or as an electric generator converting a rotational force of the shaft 10 into electrical energy, or as a motor-generator having both functions, and is mounted on, e.g., an electric car or a so-called hybrid vehicle.

The stator 1 has a stator core 11 and plural coils 12. The stator core 11 integrally has a cylindrical base portion 111, plural teeth 112 radially inwardly protruding from the base portion 111, and plural fixed portions 113 radially outwardly protruding from the base portion 111. In the example illustrated in FIG. 1, the stator core 11 has fifteen teeth 112 and the coils 12 are respectively wound around the teeth 112. The fixed portion 113 has a bolt insertion hole 113a for insertion of a bolt which is used to fix the stator core 11 to the housing.

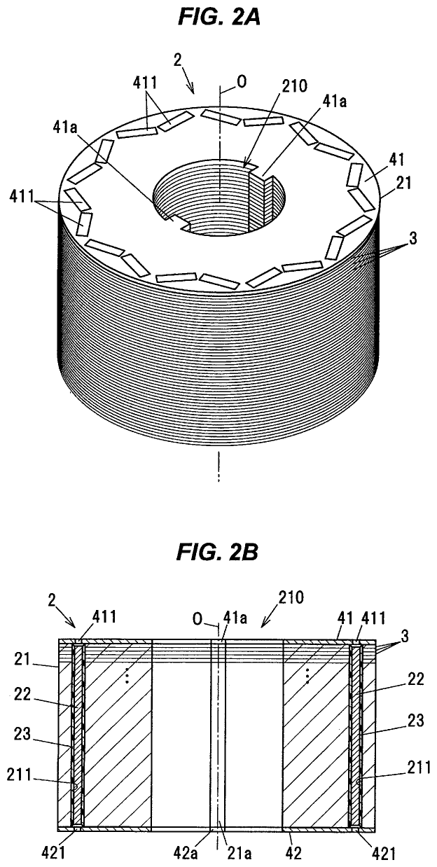

FIG. 2A is a perspective view showing the rotor 2. FIG. 2B is a cross sectional view showing the rotor 2 cut in an axial direction along a rotational axis O. The rotor 2 has the rotor core 21 and plural permanent magnets 22 held in the rotor core 21. The rotor core 21 is formed by stacking plural core plates 3 of the same shape in a stacking direction which is parallel to the rotational axis O. The number of the core plates 3 can be appropriately changed according to the required thickness of the rotor core 21. The core plate 3 is a flat plate which is punched out from an electromagnetic steel sheet by stamping.

A center hole 210 for insertion of the shaft 10 and plural housing holes 211 for respectively housing the plural permanent magnets 22 are formed on the rotor core 21. The center hole 210 and the plural housing holes 211 penetrate through the rotor core 21 in the axial direction (the stacking direction of the plural core plates 3). Although the housing holes 211 in the present embodiment extend parallel to the rotational axis O, the housing holes 211 may extend in the stacking direction of the core plates 3 with an inclination with respect to the rotational axis O.

In addition, first and second end plates 41 and 42 are attached to both axial ends of the rotor core 21 and cover both end faces of the rotor core 21. The first and second end plates 41 and 42 have the same shape and are formed of, e.g., stainless steel such as SUS304. The thickness of the first end plate 41 in the plate thickness direction is larger than the thickness of one core plate 3 in the plate thickness direction.

The rotor core 21 also has a pair of protrusions 21a respectively fitted to a pair of key grooves 10a (see FIG. 1) of the shaft 10. Since the protrusions 21a are fitted to the key grooves 10a, relative rotation of the shaft 10 with respect to the rotor core 21 is restricted.

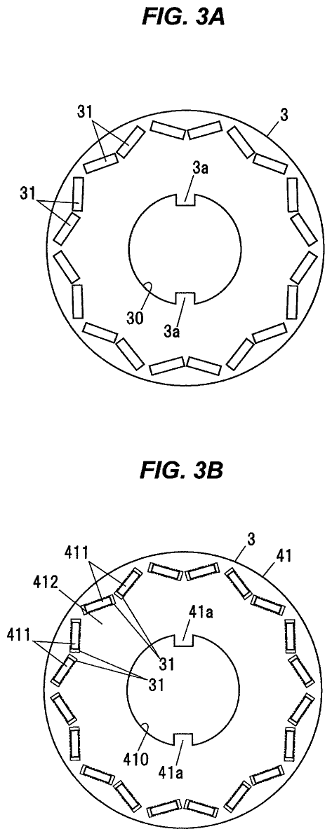

FIG. 3A is a plan view showing one core plate 3 and FIG. 3B is a plan view showing the first end plate 41. Since the first and second end plates 41 and 42 have the same shape, only the first end plate 41 will be described in reference to FIG. 3B. In the following description, the radial direction of the core plate 3 is simply referred to as the radial direction, and the direction parallel to the rotational axis O is simply referred to as the axial direction.

As shown in FIG. 3A, a center hole 30 and plural through-holes 31 for inserting magnet are formed on the core plate 3. The through-holes 31 for inserting magnet are formed in a slotted-hole shape of which long axis direction is inclined with respect to the radial direction and circumferential direction of the core plate 3. The core plate 3 also has a pair of tongue pieces 3a. The protrusions 21a of the rotor core 21 are composed of the tongue pieces of the plural core plates 3.

As shown in FIG. 3B, a center hole 410 having the same shape as the center hole 30 of the core plate 3 and plural rectangular slotted holes 411 arranged to overlap with portions of the plural through-holes 31 are formed on the first end plate 41. The first end plate 41 also has a pair of tongue pieces 41a at the positions corresponding to the tongue pieces 3a of the core plate 3. The pair of tongue pieces 41a are respectively fitted to the pair of key grooves 10a (see FIG. 1) of the shaft 10.

The center hole 410 of the first end plate 41 is provided at a position overlapping the center hole 30 of the core plate 3 in the axial direction.

When the plural core plates 3 and the first and second end plates 41 and 42 are stacked, the respective center holes 30 of the core plates 3 and the center holes 410, 420 of the first and second end plates 41 and 42 are in communication with each other and form the center hole 210, while the respective plural through-holes 31 for inserting magnet are in communication with each other and form the housing holes 211.

Each permanent magnet 22 is a quadratic prism having a rectangular shape on a cross section orthogonal to the longitudinal direction, and is fixed to the rotor core 21 by a resin 23 filled in the housing hole 211. The longitudinal end faces of the permanent magnet 22 are covered with the resin 23. The permanent magnet 22 is, e.g., a bar-shaped magnetically hard material formed by sintering powder of ferrite or neodymium, etc., and is not magnetized before being housed in the housing hole 211 but is magnetized after fixed to the rotor core 21.

### Method for Manufacturing the Rotor

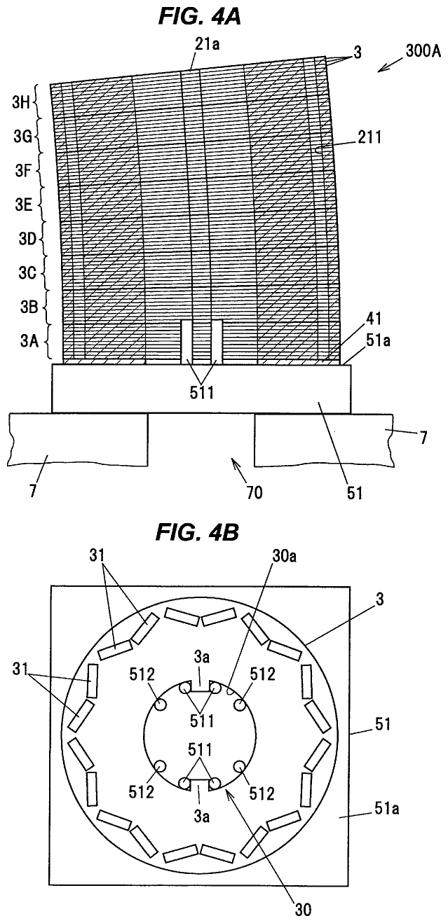

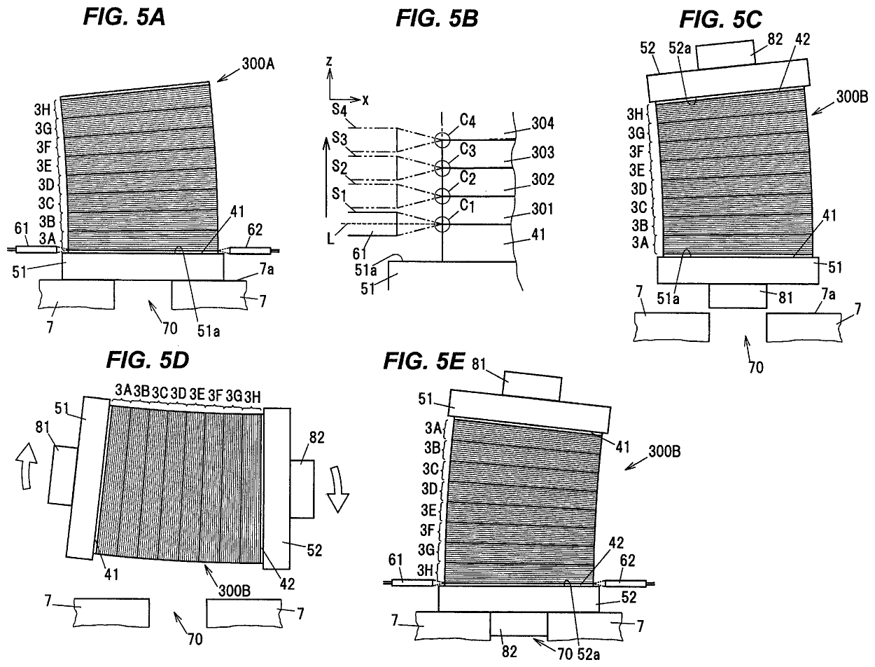

Next, a method for manufacturing the rotor 2 will be described in reference to FIGS. 4 and 5. FIG. 4A is an explanatory diagram illustrating a preparation step and FIG. 4B is a plan view showing a first laminated body shown in FIG. 4A when viewed in a direction along the rotational axis. FIGS. 5A to 5E are explanatory diagrams illustrating a welding step in which welding is performed on a second laminated body formed by stacking the plural core plates 3 and the first and second end plates 41 and 42, and the plates at both ends in the stacking direction are joined. FIG. 5B is an enlarged explanatory diagram illustrating welded joints of the plural core plates 3 and the first end plate 41. In FIGS. 4A and 5, the bottom side of the drawing is the lower side in the vertical direction and the top side of the drawing is the upper side in the vertical direction. Hereinafter, “upper” and “lower” mean the upper and lower sides in the vertical direction.

The method for manufacturing the rotor 2 in the present embodiment is a manufacturing method to manufacture a laminated structure in which a second laminated body 300B is formed by stacking the rotor core 21 and the first and second end plates 41 and 42 and plural core plates 3 as plural metal plates located at both ends in the stacking direction and the first and second end plates 41 and 42 are welded to each other, and the method includes a preparation step, a first welding step, an inverting step and a second welding step.

In the preparation step, a first laminated body 300A consisting of the first end plate 41 and the plural core plates 3 is mounted on a mounting surface 51a of a first base member 51, as show in FIG. 4A. The first base member 51 is arranged on a horizontal surface 7a of a base stage 7. The mounting surface 51a of the first base member 51 is a horizontal surface which is parallel to the horizontal direction in a state of being arranged on the surface 7a of the base stage 7, and the first end plate 41 and the plural core plates 3 are sequentially stacked on the mounting surface 51a. Here, the “placing surface” of the invention includes a horizontal surface in contact with the vertically lowermost metal plate of the laminated body which is formed by stacking plural metal plates, and the mounting surface 51a of the first base member 51 is one form of the “placing surface”. A notched opening 70 is formed on the base stage 7 to allow a first arm 81 of a robotic arm (described later) to be inserted.

The plural core plates 3 are grouped into several blocks each coupled in the plate thickness direction, and the blocks are stacked. In the example described in the present embodiment, ten core plates 3 are stacked to form one block, and eight blocks 3A to 3H are stacked. However, the number of the core plates 3 included in one block and the number of blocks to be stacked can be appropriately changed according to the thickness of the core plate 3, etc. In addition, although an example in which each block includes the same number of the core plates 3 will be described in the present embodiment, each block may include a different number of core plates 3.

The first to eighth blocks 3A to 3H are sequentially stacked such that the first block 3A is located lowermost and the eighth block 3H is located uppermost, and the rotor core 21 is thereby obtained. Into the housing holes 211 of the rotor core 21 which is mounted on the first base member 51, the permanent magnets 22 are inserted and the resin 23 is injected. Thus, the first to eighth blocks 3A to 3H are fixed to each other in the stacking direction by the resin 23. In FIG. 4A, illustration of the permanent magnets 2 and the resin 23 is omitted for the purpose of convenience.

As shown in FIG. 4B, four first pins 511 for circumferentially positioning the first laminated body 300A and four second pins 512 for radially positioning the first laminated body 300A are provided on the first base member 51 and protrude from the mounting surface 51a of the first base member 51. Although the same number of the first and second pins 511 and 512 having the same shape are provided in the present embodiment, the shape may be different and the number is not limited thereto. In addition, although the axial length of the first and second pins 511 and 512 in the present embodiment is equal to the thickness of a laminated body consisting of the first end plate 41 and eleven core plates 3 stacked thereon, it is not limited thereto and can be appropriately changed according to the thickness of the core plate 3 or the thickness of the rotor core 21, etc.

Two first pins 511 are provided at positions sandwiching one of the tongue pieces 3a of each core plate 3 in the circumferential direction and are in contact with an inner peripheral surface 30a of the center hole 30 of each core plate 3. Other two first pins 511 are provided at positions sandwiching the other tongue piece 3a of each core plate 3 in the circumferential direction and are in contact with the inner peripheral surface 30a of the center hole 30 of each core plate 3. This restricts relative rotation of the first laminated body 300A with respect to the first base member 51.

The four second pins 512 are arranged in the center holes 30 of the core plates 3 of the rotor core 21 at equal intervals in the circumferential direction and are in contact with the inner peripheral surfaces 30a of the core plates 3. This restricts radial movement of the first laminated body 300A with respect to the first base member 51.

If the core plate 3 has a thickness error in the radial direction and when the plural core plates 3 are stacked, the first laminated body 300A tilts with respect to the axial direction due to the accumulated thickness error, as shown in FIG. 4A. In FIG. 4A, the tilt of the first laminated body 300A is exaggerated to make the explanation clear.

In the first welding step, in a state that the first laminated body 300A is placed on the mounting surface 51a of the first base member 51, welding is performed on the outer peripheral portions of plural core plates 3 as plural metal plates and the first end plate 41 which lie on top of each other at the lower end in the stacking direction of the first laminated body 300A, as shown in FIG. 5A. In the present embodiment, the outer peripheral portions of the first end plate 41 and four core plates 3 (first to fourth core plates 301 to 304 described later in reference to FIG. 5B) thereon, which lie on top of each other at the lower end in the stacking direction, are welded to each other.

In this regard, however, in the first welding step, it is only necessary to weld at least the lowermost first end plate 41 to the core plate 3 adjacent thereto, and the four core plates 3 do not necessarily need to be welded to each other. The metal plates to be welded in the first welding step can be appropriately changed according to the thickness of the rotor core 21 or the core plate 3, etc.

In the first welding step, welding is performed using first and second welding torches 61 and 62 which emit laser light. The first and second welding torches 61 and 62 are arranged at positions sandwiching the rotor core 21 in the radial direction and are movable upward and downward within a predetermined range in the vertical direction. Laser welding is used as the welding method, in which the outer peripheral portion of the laminated body is irradiated with laser light having a light axis L (shown in FIG. 5B) in the horizontal direction. Movement of the first and second welding torches 61 and 62 is controlled with high accuracy based on, e.g., image information from a camera (not shown), etc.

In the first welding step, laser welding is performed to join the first end plate 41 located lowermost in the stacking direction of the first laminated body 300A to the core plate 3 adjacent to the first end plate 41, and after that, laser welding for joining the core plates 3 of the first block 3A to each other is sequentially performed. Since the motion of the second welding torch 62 is the same as the motion of the first welding torch 61, only the first welding torch 61 will be described in reference to FIG. 5B.

As shown in FIG. 5B, laser welding is continuously performed while moving the first welding torch 61 in the up/down direction from a welding start position S₁ to a welding end position S₄. The first welding torch 61 moves toward the upper side in the vertical direction (the z direction shown in the drawing) in the order of the welding start position S₁, a second welding position S₂, a third welding position S₃ and the welding end position S₄. Regarding the position in a direction orthogonal to the vertical direction (i.e., the position in the z direction in the drawing), the first welding torch 61 is arranged at a predetermined position preliminarily set for the welding start position S₁ and is then controlled to move only in the z direction after welding is started.

Hereinafter, for convenience of explanation, the core plate 3 adjacent to the first end plate 41 in the stacking direction is defined as the first core plate 301, the core plate 3 located on the first core plate 301 is defined as the second core plate 302, the core plate 3 located on the second core plate 302 is defined as the third core plate 303, and the core plate 3 located on the third core plate 303 is defined as the fourth core plate 304.

At the welding start position S₁, a first welding target portion C₁ provided between the outer peripheral portion of the first end plate 41 and the outer peripheral portion of the first core plate 301 is irradiated with laser light which is emitted from the first welding torch 61 and has the light axis L along the horizontal direction. The first end plate 41 and the first core plate 301 are thereby joined.

Next, the first welding torch 61 is moved to the second welding position S₂ and applies laser light to a second welding target portion C₂ provided between the outer peripheral portion of the first core plate 301 and the outer peripheral portion of the second core plate 302. The first core plate 301 and the second core plate 302 are thereby joined. After that, the first welding torch 61 is sequentially moved to the third welding position S₃ and the welding end position S₄ and applies laser light to a third welding target portion C₃ and a fourth welding target portion C₄ in the same manner. Thus, the second core plate 302 and the third core plate 303 are joined, and the third core plate 303 and the fourth core plate 304 are joined. Once laser welding at the welding end position S₄ is completed, the first welding torch 61 is moved back to the welding start position S₁ which is the initial position. The first welding step is thereby finished and the process proceeds to the inverting step. As such, in the first welding step, plural core plates 3 including the first end plate 41 located lowermost in the stacking direction are welded to each other by moving the first and second welding torches 61 and 62 in the up/down direction.

The inverting step is a step in which the second laminated body 300B formed by stacking the plural core plates 3 and the first and second end plates 41 and 42 is vertically inverted upside down and is mounted on the base stage 7. The inverting step will be described in detail below.

In the inverting step, firstly, the second end plate 42 and a second base member 52 having the same shape as the first base member 51 are sequentially stacked on the vertically uppermost core plate 3 of the first laminated body 300A, as shown in FIG. 5C. Then, the first arm 81 is arranged in the notched opening 70 of the base stage 7 while arranging a second arm 82 above the second base member 52, and a laminated body consisting of the second laminated body 300B and the first and second base members 51 and 52 (hereinafter, simply referred to as “composite laminated body”) is then gripped in the stacking direction by the first and second arms 81 and 82. The composite laminated body is lifted up by the motion of the first and second arms 81 and 82 and is upwardly separated from the base stage 7.

Next, as shown in FIG. 5D, the composite laminated body is inverted upside down by the first and second arms 81 and 82. In more detail, in the inverting step, the second base member 52 is inverted together with the first base member 51 and the first laminated body 300A in a state that the first laminated body 300A is sandwiched between the second base member 52 and the first base member 51. Only end portions of the first and second arms 81 and 82 are shown in FIGS. 5C to 5E.

The composite laminated body inverted upside down is placed on the base stage 7 again and the second arm 82 is arranged in the notched opening 70 of the base stage 7. In this state, the second base member 52 sits on the surface 7a of the base stage 7 and the second laminated body 300B is placed on a mounting surface 52a of the second base member 52. Then, the process proceeds to the second welding step. The mounting surface 52a of the second base member 52 after the inverting step is a horizontal surface in contact with the second end plate 42 now located vertically lowermost in the second laminated body 300B and is one form of the “placing surface” of the invention.

The second welding step is performed after the inverting step and is a step in which the outer peripheral portions of plural core plates 3 as plural metal plates and the second end plate 42 lying on top of each other at the lower end in the stacking direction of the second laminated body 300B are welded to each other in a state that the second laminated body 300B is placed on the mounting surface 52a of the second base member 52.

In the present embodiment, the outer peripheral portions of the second end plate 42 and four core plates 3 thereon, which lie on top of each other at the lower end in the stacking direction, are welded, as shown in FIG. 5E. In this regard, however, in the second welding step, it is only necessary to weld at least the second end plate 42 located lowermost in the stacking direction of the second laminated body 300B to the core plate 3 adjacent to the second end plate 42, and the four core plates 3 do not necessarily need to be welded to each other. The metal plates to be welded in the second welding step can be appropriately changed according to the thickness of the rotor core 21 or the core plate 3, etc.

In the second welding step, laser welding is performed to join the second end plate 42 located lowermost in the stacking direction of the second laminated body 300B to the core plate 3 adjacent to the second end plate 42, and after that, laser welding for joining the core plates 3 of the eighth block 3H to each other is sequentially performed, in the same manner as described in reference to in FIG. 5B to explain the motion of the first welding torch 61 in the first welding step.

At this time, the welding target portion between the outer peripheral portion of the second end plate 42 and the outer peripheral portion of the core plate 3 and the welding target portions between the outer peripheral portions of the four core plates 3 stacked on the second end plate 42 are irradiated with laser and sequentially joined while upwardly moving the first and second welding torches 61 and 62 only in the z direction, and the second welding step is then finished. As such, in the second welding step, plural core plates 3 including the second end plate 42 located lowermost in the stacking direction are welded to each other by moving the first and second welding torches 61 and 62 in the up/down direction.

### Functions and Effects of the Embodiment

In the embodiment, the second laminated body 300B formed by stacking the plural core plates 3 and the first and second end plates 41 and 42 is vertically inverted upside down and is placed on the mounting surface 52a of the second base member 52 in the inverting step. Therefore, it is possible to perform welding only on the lower end side in the stacking direction at which an impact of thickness error present in the core plates 3 is small. It is thereby possible to improve quality without being affected by parallelism associated with the thickness error of the core plates 3.

In more detail, in case that, e.g., the method for manufacturing the rotor 2 does not include the inverting step, the first and second welding torches 61 and 62 need to be moved to the upper side of the laminated body after welding the lower end of the laminated body. In this case, since the upper end side of the laminated body, which is farther in the stacking direction from the mounting surface 51a of the first base member 51, is more affected by parallelism associated with the accumulated thickness error of the core plates 3, a distance of the first and second welding torches 61 and 62 from the outer peripheral portion of the laminated body in the x direction changes with the tilt of the laminated body with respect to the stacking direction of the laminated body and this may lead to quality degradation such as poor welding.

In contrast, in the present embodiment, by inverting the second laminated body 300B to make the second laminated body 300B placed on the mounting surface 52a of the second base member 52, it is possible to perform welding only on the lower end side in the stacking direction at which an impact of the accumulated thickness error of the core plates 3 is small. Therefore, misalignment between the welding positions as described above does not occur, variation in welded joint strength among products is reduced, and it is thereby possible to stabilized weld quality.

In addition, in the present embodiment, since the first and second welding torches 61 and 62 need to be moved only vertically in the up/down direction in the first and second welding steps, it is not necessary to control the position in the direction orthogonal to the vertical direction (in the x direction). This allows an equipment required for welding to be simplified, thereby reducing equipment investment. In addition, since time required for position control is reduced, the welding step can be shortened.

Also, in the present embodiment, since the metal plate located lowermost in the stacking direction of the laminated body and the metal plate adjacent to the lowermost metal plate are laser-welded in the first and second welding steps, it is possible to prevent radial misalignment of the rotor 2 caused by rotation. In more detail, since stress caused by rotation of the rotor 2 is concentrated at both axial ends of the rotor core 21, the radial position of the core plates 3 located on the both axial ends of the laminated body may change. In the present embodiment, change in the radial position of the core plates 3 due to the rotation of the rotor 2 is prevented by welding and joining the core plates 3 to each other at the both axial ends of the laminated body.

Also, in the present embodiment, the through-holes 31 formed on the plural core plates 3, excluding the first and second end plates 41 and 42 located lowermost respectively during the first welding and the second welding step, are in communication with each other and form the plural housing holes 211 for housing the permanent magnets 22, and plural slotted holes 411 and 421 of the first and second end plates 41 and 42 are smaller than the housing holes 211 which are thereby partially covered with the first and second end plates 41 and 42. Therefore, the permanent magnets 22 are prevented from coming out.

Although the embodiment the invention has been described, the invention according to claims is not to be limited to the embodiment. Further, please note that all combinations of the features described in the embodiment are not necessary to solve the problem of the invention.

Also, the invention can be appropriately modified and implemented without departing from the gist thereof. For example, although the example of mounting the rotation electrical machine 100 on a vehicle has been described in the embodiment, the intended use of the rotation electrical machine 100 is not limited thereto.

1. A method for manufacturing a laminated structure that comprises a laminated body formed by stacking a plurality of metal plates and is configured such that the plurality of metal plates located at both ends in a stacking direction are welded to each other, the method comprising:
firstly welding outer peripheral portions of the plurality of metal plates that lie on top of each other at a lower end of the laminated body placed on a placing surface;
after the first welding, vertically inverting the laminated body upside down and placing the laminated body in position; and
after the inverting, secondly welding outer peripheral portions of the plurality of metal plates that lie on top of each other at a lower end of the laminated body.

2. The method according to claim 1, wherein the first welding is performed, in a state that the laminated body is placed on the placing surface of a first base member, to weld the outer peripheral portions of the plurality of metal plates lying on top of each other at the lower end on the first base member side, the inverting is performed to invert a second base member together with the first base member and the laminated body in a state that the laminated body is sandwiched between the second base member and the first base member, and the second welding is performed, in a state that the laminated body is placed on a placing surface of the second base member, to weld the outer peripheral portions of the plurality of metal plates lying on top of each other at the lower end on the second base member side.

3. The method according to claim 1, wherein the plurality of metal plates are welded to each other using laser welding that is achieved by irradiating the outer peripheral portions with laser light having a light axis in the horizontal direction, and, among the plurality of metal plates, at least the lowermost metal plate and the metal plate adjacent thereto are laser-welded together in the first welding and the second welding.

4. The method according to claim 3, wherein torches emitting the laser light are movable upward and downward within a predetermined range in the vertical direction, and a plurality of metal plates including the lowermost metal plate are welded to each other in the first welding and the second welding by moving the torches upward and downward.

5. The method according to claim 1, wherein the laminated structure comprises a rotation electrical machine rotor used in a rotation electrical machine, through-holes formed on the plurality of metal plates, excluding a pair of metal plates located lowermost respectively during the first welding and the second welding, are in communication with each other and form housing holes for housing permanent magnets, and the pair of metal plates at least partially covers the housing holes.
